(19) United States
(12) Patent Application Publication
(10) Pub. No.: US 2025/0379539 A1
(43) Pub. Date: Dec. 11, 2025

(54) POWER TOOL

(71) Applicant: Nanjing Chervon Industry Co., Ltd., Nanjing (CN)

(72) Inventors: Dezhong Yang, Nanjing (CN); Tianxiao Xu, Nanjing (CN); Qi Du, Nanjing (CN); Xianjing Shao, Nanjing (CN)

(21) Appl. No.: 19/308,760

(22) Filed: Aug. 25, 2025

Related U.S. Application Data
(63) Continuation of application No. PCT/CN2024/082699, filed on Mar. 20, 2024.

(30) Foreign Application Priority Data
Mar. 24, 2023 (CN) 202310302604.0

(51) Int. Cl. H02P 29/50; B24B 47/12

(52) U.S. Cl. CPC H02P 29/50; B24B 47/12

(57) ABSTRACT

A power tool includes: an electric motor including a rotor and a plurality of stator windings; a power interface having at least a positive electrode interface and a negative electrode interface and configured to be connected to a power supply; and a control circuit connected between the power interface and the electric motor and configured to control the electric motor to operate. The control circuit includes: a first power line connected to the positive electrode interface; a second power line connected to the negative electrode interface; and a plurality of noise suppression devices configured to suppress noise on a side of the electric motor. The plurality of noise suppression devices includes a first noise suppression device, a first terminal of the first noise suppression device is connected to the plurality of stator windings, and a second terminal of the first noise suppression device is connected to the first power line.

### RELATED APPLICATION INFORMATION

This application is a continuation of International Application Number PCT/CN2024/082699, filed on Mar. 20, 2024, through which this application also claims the benefit under 35 U.S.C. § 119(a) of Chinese Patent Application No. No. 202310302604.0, filed on Mar. 24, 2023, which applications are incorporated herein by reference in their entireties.

### TECHNICAL FIELD

The present application relates to the field of power tools, for example, a high-voltage brushless power tool.

### BACKGROUND

For high-voltage brushless power tools, a relatively low power factor affects the electromagnetic compatibility of the whole machine and thus affects the efficiency with which the whole machine utilizes electrical energy supplied by a power supply.

### SUMMARY

A power tool includes an electric motor including a rotor and multi-phase stator windings; a power interface configured to be connected to a power supply; and a control circuit connected between the power interface and the electric motor and configured to control the electric motor to operate. The control circuit includes at least a driver circuit including multiple switching elements and configured to drive the electric motor to operate; a power circuit having at least two operating states; and a controller configured to, in the case where a bus voltage in a loop of the control circuit is greater than a back electromotive force of the stator windings, control the power circuit to operate in a first operating state and, in the case where the bus voltage is less than or equal to the back electromotive force, control the power circuit to operate in a second operating state.

In an example, in the case where the power circuit operates in the first operating state, a current flows through the electric motor; and in the case where the power circuit operates in the second operating state, a current flows through the electric motor.

In an example, the power circuit includes at least a power switch and an inductor, the inductor is connected in series on the loop of the control circuit, the power switch is connected in parallel to two ends of a bus of the control circuit, and a control terminal of the power switch is electrically connected to the controller.

In an example, the controller is configured to, in the case where the bus voltage is greater than the back electromotive force, control the power switch to be turned off and, in the case where the bus voltage is less than or equal to the back electromotive force, control the power switch to be turned on at a preset frequency.

In an example, a time during which the power circuit operates in the first operating state is positively correlated to a load of the power tool, and a time during which the power circuit operates in the second operating state is negatively correlated to the load.

In an example, in a process of the power switch being turned on at a preset frequency, the inductor is charged to an unsaturated state.

In an example, the power circuit further includes a filter capacitor connected in parallel between the power switch and the driver circuit.

A power tool includes an electric motor including a rotor and multi-phase stator windings; a power interface configured to be connected to a power supply; and a control circuit connected between the power interface and the electric motor and configured to control the electric motor to operate. The control circuit includes at least a driver circuit including multiple switching elements and configured to drive the electric motor to operate; a power circuit having at least two operating states; and a controller configured to, in the case where a bus voltage in a loop of the control circuit is greater than a preset voltage, control the power circuit to operate in a first operating state and, in the case where the bus voltage is less than or equal to the preset voltage, control the power circuit to operate in a second operating state.

In an example, the preset voltage is greater than or equal to a back electromotive force of the stator windings.

In an example, the power circuit includes at least a power switch and an inductor, the inductor is connected in series on the loop of the control circuit, the power switch is connected in parallel to two ends of a bus of the control circuit, and a control terminal of the power switch is electrically connected to the controller.

In an example, the controller is configured to, in the case where the bus voltage is greater than the preset voltage, control the power switch to be turned off and, in the case where the bus voltage is less than or equal to the preset voltage, control the power switch to be turned on at a preset frequency.

In an example, in a process of the power switch being turned on at the preset frequency, the bus voltage is greater than or equal to a back electromotive force of the stator windings.

A power tool includes an electric motor including a rotor and multi-phase stator windings; a power interface configured to be connected to a power supply; and a control circuit connected between the power interface and the electric motor and configured to control the electric motor to operate. The control circuit includes at least a driver circuit including multiple switching elements and configured to drive the electric motor to operate; a power circuit configured to adjust output power of the control circuit; and a controller electrically connected to at least the driver circuit and the power circuit. During cycles within which a bus voltage in a loop of the control circuit is greater than a back electromotive force of the stator windings, a current from the power supply is consumed; and during cycles within which the bus voltage in the loop of the control circuit is less than or equal to the back electromotive force of the stator windings, the current from the power supply is consumed and the power circuit performs power correction.

In an example, the power circuit includes at least a power switch and an inductor, the inductor is connected in series on the loop of the control circuit, the power switch is connected in parallel to two ends of a bus of the control circuit, and a control terminal of the power switch is electrically connected to the controller.

In an example, the controller is configured to, in the case where the bus voltage is greater than the back electromotive force, control the power switch to be turned off and, in the case where the bus voltage is less than or equal to the back electromotive force, control the power switch to be turned on at a preset frequency.

A power tool includes an electric motor including a rotor and multi-phase stator windings; a power interface configured to be connected to a power supply; and a control circuit connected between the power interface and the electric motor and configured to control the electric motor to operate. The control circuit includes at least a driver circuit including multiple switching elements and configured to drive the electric motor to operate; a power circuit having at least two operating states; and a controller configured to control the power circuit to switch between different operating states according to a relationship between a bus voltage in a loop of the control circuit and a back electromotive force of the stator windings.

A power tool includes: an electric motor including a rotor and a plurality of stator windings; a power interface having at least a positive electrode interface and a negative electrode interface and configured to be connected to a power supply; and a control circuit connected between the power interface and the electric motor and configured to control the electric motor to operate. The control circuit includes: a first power line connected to the positive electrode interface; a second power line connected to the negative electrode interface; and a plurality of noise suppression devices configured to suppress noise on a side of the electric motor. The plurality of noise suppression devices includes a first noise suppression device, a first terminal of the first noise suppression device is connected to the plurality of stator windings, and a second terminal of the first noise suppression device is connected to the first power line.

In an example, the plurality of noise suppression devices further includes a second noise suppression device, a third terminal of the second noise suppression device is electrically connected to the second terminal of the first noise suppression device, and a fourth terminal of the second noise suppression device is grounded.

In an example, the first noise suppression device includes a first capacitor, and the second noise suppression device includes a second capacitor.

In an example, the first noise suppression device is configured to suppress common-mode noise on the side of the electric motor.

In an example, the second noise suppression device is configured to suppress differential-mode noise on the side of the electric motor.

In an example, the plurality of noise suppression devices further includes a third noise suppression device, a fifth terminal of the third noise suppression device is connected to the positive electrode interface, and a sixth terminal of the third noise suppression device is connected to the plurality of stator windings.

In an example, the plurality of noise suppression devices further includes a fourth noise suppression device, a seventh terminal of the fourth noise suppression device is connected to the negative electrode interface, and an eighth terminal of the fourth noise suppression device is connected to the plurality of stator windings.

In an example, the electric motor includes a brushed electric motor.

In an example, the electric motor includes a brushless electric motor.

In an example, the power interface is configured to be connected to an alternating current power supply.

A power tool includes: an electric motor including a rotor and a plurality of stator windings; a power interface having at least a positive electrode interface and a negative electrode interface and configured to be connected to a power supply; and a control circuit connected between the power interface and the electric motor and configured to control the electric motor to operate. The control circuit includes at least: a first power line connected to the positive electrode interface; a second power line connected to the negative electrode interface; a driver circuit including a plurality of switching elements and configured to drive the electric motor to operate; and a first noise suppression device configured to suppress noise on a side of the electric motor. The plurality of stator windings are connected to the first power line via the first noise suppression device.

In an example, the first noise suppression device is configured to suppress common-mode noise on the side of the electric motor.

In an example, the electric motor includes a brushed electric motor.

In an example, the electric motor includes a brushless electric motor.

In an example, the power interface is configured to be connected to an alternating current power supply.

A power tool includes: an electric motor including a rotor and a plurality of stator windings; a power interface having at least a positive electrode interface and a negative electrode interface and configured to be connected to a power supply; and a control circuit connected between the power interface and the electric motor and configured to control the electric motor to operate. The control circuit includes at least: a first power line connected to the positive electrode interface; a second power line connected to the negative electrode interface; a driver circuit including a plurality of switching elements and configured to drive the electric motor to operate; a first noise suppression device configured to suppress noise on a side of the electric motor; and a second noise suppression device, wherein a terminal of the second noise suppression device is electrically connected to a terminal of the first noise suppression device, and another terminal of the second noise suppression device is grounded. The plurality of stator windings are connected to the first power line via the first noise suppression device.

In an example, the second noise suppression device is configured to suppress differential-mode noise on the side of the electric motor.

In an example, the control circuit further includes a third noise suppression device, a terminal of the third noise suppression device is connected to the positive electrode interface, and another terminal of the third noise suppression device is connected to the plurality of stator windings.

In an example, the control circuit further includes a fourth noise suppression device, a terminal of the fourth noise suppression device is connected to the negative electrode interface, and another terminal of the fourth noise suppression device is connected to the plurality of stator windings.

In an example, the first noise suppression device includes a first capacitor, and the second noise suppression device includes a second capacitor.

### BRIEF DESCRIPTION OF THE DRAWINGS

FIG. 1 is a structural view of a power tool according to an example of the present application.

FIG. 2 is a circuit block diagram of a power tool according to an example of the present application.

FIG. 3 are graphs of a relationship between a current flowing through an electric motor and a bus voltage according to an example of the present application.

FIG. 4 is a circuit block diagram of a power tool according to an example of the present application.

FIG. 5A is a graph of an alternating current signal according to an example of the present application.

FIG. 5B is a graph of a bus voltage after rectification according to an example of the

present application.

FIG. 5C is a graph of sending of a positioning pulse according to an example of the present application.

FIG. 6 is a graph of an operating curve of a power tool according to an example of the present application.

### DETAILED DESCRIPTION

The present application is described below in detail in conjunction with drawings and examples. The examples described herein are intended to explain the present application and not to limit the present application. Additionally, it is to be noted that for ease of description, only part, not all, of structures related to the present application are illustrated in the drawings.

Unless otherwise defined, all technical and scientific terms used herein have the same meanings as those commonly understood by those skilled in the art to which the present application pertains. Terms used in the specification of the present application are used only for describing the examples and not intended to limit the present application. The term “and/or” used herein indicates the inclusion of any or all combinations of one or more listed associated items.

It is to be understood by those skilled in the art that relative terms used in relation to quantities or conditions (such as “about”, “approximately”, and “substantially”) indicate the inclusion of the stated values and convey meanings as dictated by the context (for example, such terms encompass at least measurement-associated errors and tolerances associated with particular values (for example, manufacturing, assembly, and use)). The relative terms are also to be construed as disclosing a range defined by the absolute values of two endpoints. For example, the expression “from about 2 to about 4” discloses a range “from 2 to 4”.

The relative terms may represent a percentage (for example, 1%, 5%, 10%, or more) by which the stated value is increased or decreased. For example, for a range of ±10%, “about 20 V” may represent a range from 18 V to 22 V, and “about 1%” may represent a range from 0.9% to 1.1%. Other meanings of the relative terms may be understood from the context, for example, rounding. Therefore, “about 20 V” may also represent a range from 19.5 V to 20.4 V.

High-voltage brushless power tools to which the technical solutions of the present application are applicable may be grinding tools, such as a sander, a wall sander, a polisher, and an angle grinder. Alternatively, the power tools may be handheld power tools, such as a drill and a hedge trimmer. Alternatively, the power tools may be table tools, such as a table saw, a miter saw, a metal cutter, and a router. Alternatively, the power tools may be push power tools, such as a push mower and a push snow thrower. Alternatively, the power tools may be riding power tools, such as a riding mower, a riding vehicle, and an all-terrain vehicle. Alternatively, the power tools may be robotic tools, such as a robotic mower and a robotic snow thrower. In some examples, the power tools may be an electric drill, an electric lamp, an electric vehicle, and the like. In some examples, the power tools may be garden tools, such as a hedge trimmer, a blower, a mower, and a chainsaw.

Alternatively, the power tools may be decorating tools, such as a screwdriver, a nail gun, a circular saw, and a sander. In some examples, the power tools may be vegetation care tools, such as a string trimmer, a mower, a hedge trimmer, and a chainsaw. Alternatively, the power tools may be cleaning tools, such as a blower, a snow thrower, and a washer. Alternatively, the power tools may be drilling tools, such as a drill, a screwdriver, a wrench, and an electric hammer. Alternatively, the power tools may be sawing tools, such as a reciprocating saw, a jigsaw, and a circular saw. Alternatively, the power tools may be other tools, such as a lamp and a fan. Any other types of power tools that can adopt the substantial content of the technical solutions disclosed below are within the scope of the present application.

In an example of the present application, a power tool is an angle grinder 10, for example.

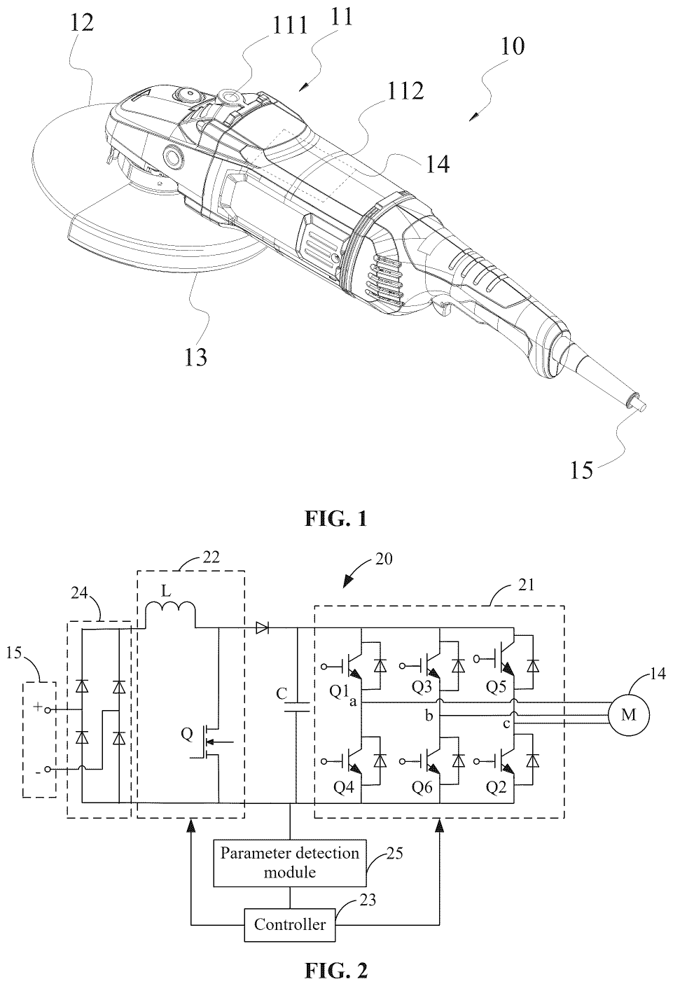

Referring to FIG. 1, the angle grinder 10 includes at least a housing 11, a grinding disc 12, a shield 13, an electric motor 14, and a power interface 15.

The housing 11 includes a head housing 111 and a body housing 112. The electric motor is accommodated in the housing 11, and the electric motor 14 is fixed to the body housing 112. The housing 11 is further formed with a grip for a user to hold. Of course, the grip may be an independent part.

The grinding disc 12 is configured to implement a grinding or cutting function. The angle grinder 10 further includes the shield 13 that at least partially covers the grinding disc 12 to implement a protective function. As a tool attachment to the angle grinder 10, the grinding disc 12 is mounted on an output shaft (not shown). The output shaft is configured for mounting or fixing the tool attachment. For the angle grinder 10, the output shaft is configured for mounting the grinding disc 12.

The electric motor 14 is accommodated in the housing 11, operatively and mechanically connected to the output shaft, and configured to drive the output shaft to rotate to drive the grinding disc 12 to operate. The electric motor 14 includes a rotor, a stator, and a motor shaft, the rotor is connected to the motor shaft and configured to drive the motor shaft to rotate, and the motor shaft is operatively connected to the output shaft. In this example, the electric motor 14 may be a brushed electric motor, a brushless electric motor, an alternating current electric motor, a direct current electric motor, an inrunner, an outrunner, or another type of electric motor, which is not limited here. In this example, the electric motor 14 may be a sensorless electric motor and has no position sensor capable of detecting a rotor position.

The power interface 15 may be a power line shown in FIG. 1, which is configured to be connected to an alternating current power supply. For example, the power interface 15 may be connected to alternating current mains electricity of 220 V. In other examples, electrical energy supplied by a battery pack may be converted by a power conversion device into an alternating current and then supplied to the power tool.

Referring to a circuit block diagram of the power tool shown in FIG. 2, a control circuit 20 for driving the electric motor 14 includes at least a driver circuit 21, a power circuit 22, and a controller 23. In this example, the control circuit 20 may further include a rectifier circuit 24.

The driver circuit 21 has output terminals electrically connected to stator windings of the electric motor 14 and is configured to transmit a current connected to the power interface 15 to the stator windings A, B, and C to drive the rotation of the electric motor 14. In an example, the driver circuit 21 includes multiple switching elements Q1, Q2, Q3, Q4, Q5, and Q6. A gate terminal of each switching element is electrically connected to the controller 23 and configured to receive a control signal from the controller 23. A drain or source of each switching element is connected to a stator winding A, B, or C of the electric motor 14. The switching elements Q1 to Q6 receive control signals from the controller 23 to change their respective on states, thereby changing the current loaded to the stator windings of the electric motor 14 by the power supply. In an example, the driver circuit 21 may be a three-phase bridge driver circuit including six controllable semiconductor power devices (such as field-effect transistors (FETs), bipolar junction transistors (BJTs), or insulated-gate bipolar transistors (IGBTs)). The switching elements may be any other types of solid-state switches, such as IGBTs or BJTs.

As shown in FIG. 2, to drive the electric motor 14 to rotate, the driver circuit 21 has multiple driving states, and in different driving states, the electric motor 14 may have different rotational speeds or different rotation directions. In the present application, the process is not described in detail in which the controller 23 controls the driver circuit 21 to change between different driving states so that the electric motor 14 has different rotational speeds or different rotation directions.

A filter capacitor C is connected in parallel to the front end of the driver circuit 21, that is, input terminals of the driver circuit 21, and the filter capacitor C is configured to filter out electromagnetic noise in the control circuit 20.

The rectifier circuit 24 is electrically connected to two terminals of the power interface 15. In an example, the rectifier circuit 24 may be a full-wave rectifier circuit composed of four diodes.

The power circuit 22 is electrically connected between the rectifier circuit 24 and the filter capacitor C. The power circuit 22 can affect a power factor of the whole control circuit 20. Generally, a back electromotive force of the stator windings varies with the rotational speed of the electric motor 14. For example, when the electric motor 14 has a high rotational speed, the back electromotive force of the windings is high, and when the electric motor has a low rotational speed, the back electromotive force of the windings is low. Therefore, during normal operation of the power tool, the back electromotive force of the stator windings varies with the rotational speed of the electric motor, so a bus voltage may be higher than the back electromotive force of the stator in some periods and lower than the back electromotive force in other periods during operation of the power tool. In the case where the bus voltage is lower than the back electromotive force of the stator windings, electrical energy supplied on a side of the power supply cannot be used by the electric motor 14, that is, no current flows through the electric motor 14. Therefore, the power factor is not high in the whole operation period of the whole machine.

In an example of the present application, an operating manner of the power circuit in the power tool is adjusted so that a utilization rate of the power supply can be ensured throughout the operation of the power tool, and the power factor of the tool can be increased.

Optionally, the power circuit 22 has at least two operating states, and the power circuit 22 may switch between different operating states according to a change of an electrical parameter in the control circuit 20. In an example, the controller 23 may control the power circuit 22 to switch an operating state according to a relationship between a bus voltage in a loop of the control circuit 20 and the back electromotive force of the stator windings.

In an example, in the case where the bus voltage is greater than the back electromotive force of the stator windings, the controller 23 may control the power circuit 22 to operate in a first operating state, and in the case where the bus voltage is less than or equal to the back electromotive force, the controller 23 may control the power circuit 22 to operate in a second operating state. The power circuit 22 in different operating states may have the same effect or different effects on the power factor of the control circuit 20.

Generally, a load of the power tool is negatively correlated to the rotational speed of the electric motor 14, where the higher the load, the lower the rotational speed of the electric motor, and vice versa. When the rotational speed is low, a time during which the bus voltage is greater than the back electromotive force of the stator windings is relatively long, and when the rotational speed is high, a time during which the bus voltage is less than or equal to the back electromotive force of the stator windings is relatively long. In this example, a time during which the power circuit 22 operates in the first operating state is positively correlated to a magnitude of the load of the power tool. For example, the higher the load, the longer the time during which the power circuit 22 operates in the first operating state, and vice versa. However, a time during which the power circuit 22 operates in the second operating state is negatively correlated to the magnitude of the load of the power tool. For example, the higher the load, the shorter the time during which the power circuit 22 operates in the second operating state, and vice versa.

In an example, the power circuit 22 may include at least a power switch Q and an inductor

L, a gate terminal of the power switch Q is electrically connected to the controller 23 and configured to receive a control signal from the controller 23, and a drain and a source of the power switch Q are connected to buses at two ends of the control circuit 20. The inductor L is connected in series on one bus of the control circuit 20.

In this example, the controller 23 may include a detection unit (not shown) capable of detecting the bus voltage or the back electromotive force of the stator windings. In the case where the bus voltage is greater than the back electromotive force of the stator windings, the controller 23 controls the power switch Q to be turned off, and the electrical energy connected to the power interface 15 flows through the inductor L and is supplied to the electric motor 14 for operation. In this process, the power circuit 22 operates in the first operating state. In the first operating state, a current flows through the windings of the electric motor 14, and the electric motor 14 can operate normally. In the case where the bus voltage is less than or equal to the back electromotive force of the stator windings, the current from the power supply cannot flow to a side of the electric motor with a higher potential. Therefore, if the power circuit 22 does not change the operating state, no current flows through the electric motor 14, and the power factor of the control circuit 20 decreases. If a current can be made flow through the windings of the electric motor 14 when the bus voltage is less than or equal to the back electromotive force of the stator windings, the electrical energy supplied by the power supply can be consumed, and it can be ensured that the whole machine has a relatively high power factor throughout the operation.

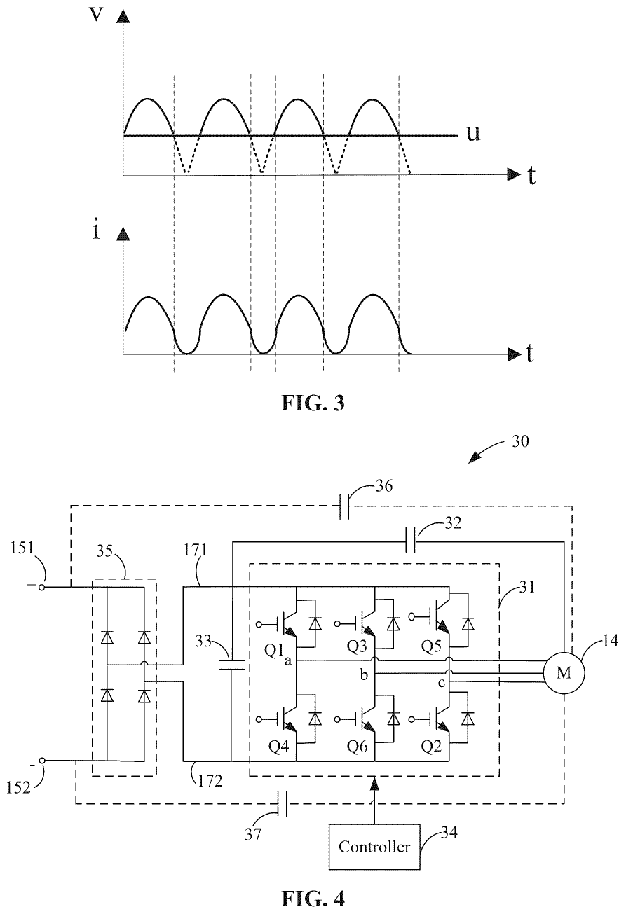

In the case where the bus voltage is less than or equal to the back electromotive force of the windings, the controller 23 may control the power switch Q to be turned on at a preset frequency. In a process of the power switch Q being turned on at the preset frequency, the inductor Lis charged by the current from the power supply when Q is turned on, and the inductor L can discharge to the electric motor 14 at the rear end when Q is turned off so that even if the bus voltage is less than or equal to the back electromotive force of the windings at the rear end, the current from the power supply can flow through the windings of the electric motor to be effectively utilized. As can be seen from a relationship between the current i flowing through the windings of the electric motor and the bus voltage v, as shown in FIG. 3, during operation of the power tool, the current varies with the bus voltage in a region where the bus voltage is greater than the back electromotive force u of the windings, and the current also varies with the bus voltage in a region where the bus voltage is less than or equal to the back electromotive force. In both the region where the bus voltage is greater than the back electromotive force and the region where the bus voltage is less than or equal to the back electromotive force, the electric motor consumes the current, and the electrical energy supplied by the power supply is effectively utilized, ensuring that the whole machine has a relatively high power factor.

In an example, when the bus voltage is less than or equal to the back electromotive force, the inductor L can be charged to an unsaturated state when the power switch Q in the power circuit 22 is turned on within one cycle, and a time for which the power switch Q is turned on within one cycle is required to ensure that the inductor L cannot be charged to a saturated state, to avoid the case where the inductor L is charged to saturation, and a bus current is too large and burns the switching elements in the control circuit 20.

In an example, the frequency at which the power switch Q is turned on may be correlated to the inductance, inductive reactance, or the like of the inductor L, and the frequency at which the power switch Q is turned on may be set according to an electrical parameter of the inductor L.

In an example, in the case where the bus voltage is greater than a preset voltage, the controller 23 may control the power circuit 22 to operate in the first operating state, and in the case where the bus voltage is less than or equal to the preset voltage, the controller 23 may control the power circuit 22 to operate in the second operating state. The preset voltage is greater than or equal to the back electromotive force of the stator windings. In this example, in the second operating state, the bus voltage is greater than the back electromotive force of the windings in the power tool.

In this example, in the case where the bus voltage is greater than the preset voltage, the controller 23 controls the power switch Q to be turned off, and the electrical energy connected to the power interface 15 flows through the inductor L and is supplied to the electric motor 14 for operation. In this process, the power circuit 22 operates in the first operating state. In the first operating state, a current flows through the windings of the electric motor 14, and the electric motor 14 can operate normally. In the case where the bus voltage is less than or equal to the preset voltage, the power switch Q is controlled to be turned on at the preset frequency so that the bus voltage is greater than the back electromotive force. In this process, the power circuit 22 operates in the second operating state to avoid the case where the current from the power supply cannot flow to the side of the electric motor with the higher potential since the bus voltage is less than the back electromotive force of the stator windings.

The operating state of the power circuit is changed according to a relationship between the bus voltage and the preset voltage, which can ensure that the bus voltage in the circuit is always greater than the back electromotive force of the windings and avoid the case where the bus voltage is lower than the back electromotive force, thereby increasing the power factor of the circuit.

In this example, a circuit board 16 is provided in the housing 11. Various electronic elements are provided on the circuit board 16. In this example, a control circuit 30 configured to drive the electric motor 14 is provided on the circuit board 16. As shown in FIG. 4, the control circuit 30 includes at least a driver circuit 31, a first noise suppression device 32, a second noise suppression device 33, a controller 34, and a rectifier circuit 35. The driver circuit 31 and the rectifier circuit 35 have the same circuit structures as those in the example shown in FIG. 2, and the controller 34 controls the driver circuit in the same manner as in the preceding example. The details are not repeated here.

In this example, output terminals of the power interface 15 are connected in parallel to the rectifier circuit 35, the second noise suppression device 33, and the driver circuit 31 in sequence. The second noise suppression device 33 is connected in parallel to the front end of the driver circuit 31, that is, input terminals of the driver circuit 31, and the second noise suppression device 33 is configured to filter out electromagnetic noise in the control circuit 30. In this example, the second noise suppression device 33 may be a noise reduction capacitor, and a type, a model, or the like of the noise reduction capacitor is not specifically limited in the present application.

To enhance the suppression effect of electromagnetic compatibility (EMC) noise on the side of the electric motor 14, the first noise suppression device 32 may be further provided. In this example, a power line connected to a positive electrode interface 151 of the power interface 15 is defined as a first power line 171, and a power line connected to a negative electrode interface 152 of the power interface 15 is defined as a second power line 172. The first power line 171 may also be referred to as a positive line, and the second power line 172 may also be referred to as a ground line. Two terminals of the second noise suppression device 33 are connected to the first power line 171 and the second power line 172 at the rear end of the rectifier circuit 35, respectively. A terminal of the first noise suppression device 32 is connected to stator cores, and the other terminal of the first noise suppression device 32 is connected to the first power line 171 at the rear end of the rectifier circuit 35. The stator cores of the electric motor 14 are connected to the first power line 171 via the first noise suppression device 32. As can be seen from FIG. 4, one terminal of the first noise suppression device 32 is connected to the stator cores, and the other terminal of the first noise suppression device 32 is connected to the second noise suppression device 33 and is grounded via the second noise suppression device 33 so that common-mode noise and differential-mode noise in the control circuit 30 can be eliminated through the two noise suppression devices, achieving a better noise suppression effect.

Referring to FIG. 4, the control circuit 30 may further include a third noise suppression device 36 or a fourth noise suppression device 37. A terminal of the third noise suppression device 36 is electrically connected to the stator cores, and the other terminal of the third noise suppression device 36 is connected to the first power line 171 at the front end of the rectifier circuit 35. A terminal of the fourth noise suppression device 37 is electrically connected to the stator cores, and the other terminal of the fourth noise suppression device 37 is connected to the second power line 172 at the front end of the rectifier circuit 35.

In this example, the front end and the rear end are defined based on a direction in which the current flows out of the power interface 15, a connection point closer to the power interface is referred to as the front end, and a node farther from the power interface is referred to as the rear end. In an example, the front end may be a node at or before an input terminal of a circuit module or electronic element, and the rear end may be a node at or after an output terminal of the circuit module or electronic element. For example, the front end of the rectifier circuit 35 is a node before an input terminal of the rectifier circuit 35 or may be a node at an output terminal of the power interface 15.

In this example, the control circuit 30 includes at least the first noise suppression device 32. The first noise suppression device 32, the second noise suppression device 33, the third noise suppression device 36, and the fourth noise suppression device 37 may be capacitors of the same type or capacitors of different types. In other examples, the control circuit 30 may include at least one of the first noise suppression device 32, the second noise suppression device 33, the third noise suppression device 36, or the fourth noise suppression device 37.

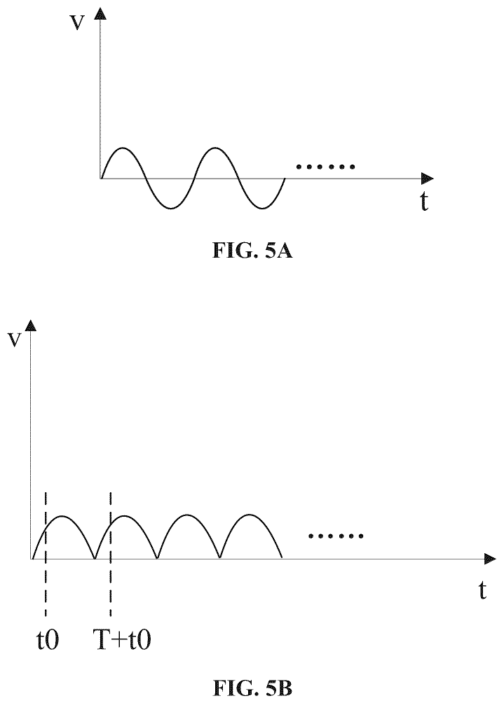

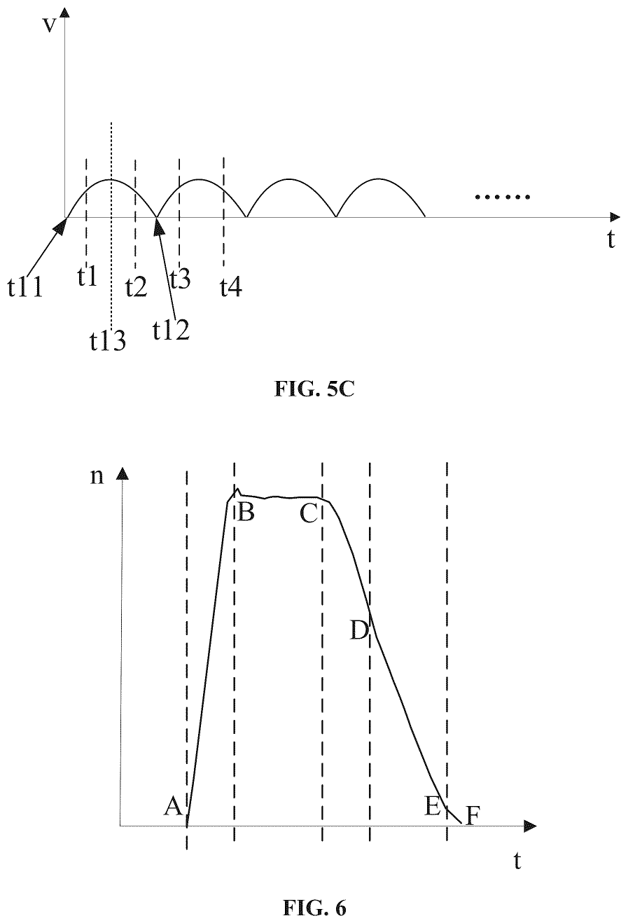

In this example, the alternating current power supply connected to the power interface 15 can continuously output an alternating current signal having a certain frequency or period and shown in FIG. 5A. After rectification by the rectifier circuit 24, a periodic signal shown in FIG. 5B, that is, a waveform diagram of a bus voltage after rectification in the control circuit 20, can be obtained. To detect the rotor position of the electric motor, the controller 23 may send a positioning pulse. Due to different rotor positions, every time the positioning pulse is sent, the bus voltage has a certain sudden change due to an effect of the positioning pulse, and a degree of the sudden change of the bus voltage may reflect the rotor position. Therefore, the controller 23 may send the positioning pulse to identify the rotor position of the electric motor. However, as can be seen from FIG. 5B, the bus voltage after rectification is a periodic wave in the shape of steamed buns. If the controller 23 sends the positioning pulse twice at a rising stage of the bus voltage and a peak position of the bus voltage, the bus voltages corresponding to the two positioning pulses fluctuate greatly, affecting the detection accuracy of the rotor position.

Therefore, to ensure the detection accuracy of the rotor position, the controller 23 needs to control a moment at which the positioning pulse is sent or a time interval at which positioning pulses are sent, so as to ensure that the bus voltage is substantially consistent or consistent within a certain error range every time the positioning pulse is sent.

In this example, the control circuit 20 may further include a parameter detection module 25 capable of detecting information about a power signal, for example, a signal sending period, a signal sending frequency, or an average of the signal sending period of the power signal. In an example, the controller 23 may include the parameter detection module 25 or the controller 23 may directly detect the information about the power signal. In an example, when detecting the period or frequency of the alternating current signal, the controller 23 or the parameter detection module 25 may identify zero crossings of the signal after power-on and calculate a time interval between two zero crossings, where the time interval may be used as the signal sending period T. In an example, the controller 23 may acquire a period average after calculating multiple periods T.

In an example, as shown in FIG. 5B, the controller 23 may record a moment to at which the positioning pulse is sent for the first time and determine a moment at which the positioning pulse is sent for the second time to be t0+T according to the signal sending period T and the moment to at which the positioning pulse is sent for the first time, where the time T may be increased every time the subsequent positioning pulse is sent.

As can be seen from FIG. 5B, a pulse sending period determined according to the moment t0 at which the positioning pulse is sent for the first time and the period T is also periodic. The bus voltage is substantially consistent at two moments in each wave in the shape of a steamed bun, and a rising wave and a falling wave are substantially symmetrical with a peak as a symmetry axis. The bus voltage has substantially consistent amplitudes at intersections between the bus voltage waveform in FIG. 5C and an assumed reference line, that is, moments t1, t2, t3, and t4 correspond to substantially consistent bus voltages. The reference line may be a line parallel to the abscissa in the voltage waveform diagram. One period T exists between the moment t1 and the moment t3, one period T exists between the moment t2 and the moment t4, a time interval between the moment t1 and the moment t2 is less than T, and a time interval between the moment t2 and the moment t3 is also less than T. If the controller 23 marks the moment at which the positioning pulse is sent for the first time as t1, the positioning pulse is sent periodically at neither the moment t2 nor the moment t4.

In an example, the controller 23 may mark a first moment at which the positioning pulse is sent for the first time, identify zero crossings of the signal sending period where the first moment is located, and determine, according to the first moment, the zero crossings, and the signal sending period, a moment at which at least one positioning pulse is sent. For example, in FIG. 5C, it is assumed that the positioning pulse is sent for the first time at the moment t1, two zero crossings t11 and t12 exist in the signal sending period where the moment t1 is located, and a middle moment between the two zero crossings is t13. Then, after the first moment t1 at which the positioning pulse is sent for the first time, the next moment t2 at which the positioning pulse is sent may be determined according to the first moment t1, T, and one zero crossing t11. In this example, t2=T−t1+t11, the third moment at which the positioning pulse is sent satisfies that t3=t1+T, and the fourth moment at which the positioning pulse is sent satisfies that t4=t2+T=2T−t1+t11. Of course, the moments at which the positioning pulse is sent after t1 may be calculated according to the zero crossing t12, and the details are not repeated here.

In conjunction with the particularity in the period of the alternating current signal, the bus voltage can be substantially consistent every time the positioning pulse is sent, thus ensuring the detection accuracy of the rotor position of the electric motor.

In an example, the controller 23 may select a rising edge or a falling edge of the bus voltage to send the positioning pulse for the first time.

In an example, a time-rotational speed curve from the startup to braking of the electric motor 14 controlled by the control circuit 20 is shown in FIG. 6, where the horizontal axis represents the operating time of the power tool from startup to braking, and the vertical axis represents the rotational speed of the electric motor. In this example, A to B represents a startup operation stage of the power tool, A represents a startup moment of the tool, B to C represents a constant-speed operation stage of the electric motor, a braking signal is detected at a moment C, and C to F represents the whole braking process. It is defined that a slope of a startup curve within any period of the whole startup process from A to B is K11, a slope of a startup curve in the whole startup process is K1, a curve slope of the whole braking process from C to F is K2, and a slope of a braking curve within any period is K21. Then, K2 is less than K1, K2 is less than K11, K21 is less than K1, and K21 is less than K11. In the case where the power tool brakes according to the above braking curve, a braking time period is ensured, and the safety of braking is also ensured, for example, a brake pad of the angle grinder can be prevented from being detached.

In an example, the braking process shown in FIG. 6 may be divided into a first speed reduction drive stage from C to D, a second speed reduction drive stage from D to E, and a hard braking stage from E to F. On the basis of ensuring the relationships between the slopes of the braking curves and the slopes of the startup curves, a control manner in each stage is not limited in this example.

What is claimed is:

1. A power tool, comprising:
an electric motor comprising a rotor and a plurality of stator windings;
a power interface having at least a positive electrode interface and a negative electrode interface and configured to be connected to a power supply; and
a control circuit, connected between the power interface and the electric motor, configured to control the electric motor to operate and comprising a first power line connected to the positive electrode interface, a second power line connected to the negative electrode interface, and a first noise suppression device, configured to suppress noise on a side of the electric motor, having a first terminal connected to the plurality of stator windings and a second terminal connected to the first power line.

2. The power tool according to claim 1, further comprising a second noise suppression device having a first terminal electrically connected to the second terminal of the first noise suppression device and a second terminal connected to ground.

3. The power tool according to claim 2, wherein the first noise suppression device comprises a first capacitor, and the second noise suppression device comprises a second capacitor.

4. The power tool according to claim 1, wherein the first noise suppression device is configured to suppress common-mode noise on the side of the electric motor.

5. The power tool according to claim 2, wherein the second noise suppression device is configured to suppress differential-mode noise on the side of the electric motor.

6. The power tool according to claim 1, further comprising a second noise suppression device having a first terminal connected to the positive electrode interface and a second terminal connected to the plurality of stator windings.

7. The power tool according to claim 1, further comprising a second noise suppression device having a first terminal connected to the negative electrode interface and a second terminal connected to the plurality of stator windings.

8. The power tool according to claim 1, wherein the electric motor comprises a brushed electric motor.

9. The power tool according to claim 1, wherein the electric motor comprises a brushless electric motor.

10. The power tool according to claim 1, wherein the power interface is configured to be connected to an alternating current power supply.

11. A power tool, comprising:
an electric motor comprising a rotor and a plurality of stator windings;
a power interface having at least a positive electrode interface and a negative electrode interface and configured to be connected to a power supply; and
a control circuit, connected between the power interface and the electric motor, configured to control the electric motor to operate and comprising a first power line connected to the positive electrode interface, a second power line connected to the negative electrode interface, a driver circuit, configured to drive the electric motor to operate, comprising a plurality of switching elements, and a first noise suppression device, configured to suppress noise on a side of the electric motor, connecting the plurality of stator windings to the first power line.

12. The power tool according to claim 11, wherein the first noise suppression device is configured to suppress common-mode noise on the side of the electric motor.

13. The power tool according to claim 11, wherein the electric motor comprises a brushed electric motor.

14. The power tool according to claim 11, wherein the electric motor comprises a brushless electric motor.

15. The power tool according to claim 11, wherein the power interface is configured to be connected to an alternating current power supply.

16. A power tool, comprising:
an electric motor comprising a rotor and a plurality of stator windings;
a power interface having at least a positive electrode interface and a negative electrode interface and configured to be connected to a power supply; and
a control circuit, connected between the power interface and the electric motor, configured to control the electric motor to operate and comprising a first power line connected to the positive electrode interface, a second power line connected to the negative electrode interface, a driver circuit, configured to drive the electric motor to operate, comprising a plurality of switching elements, a first noise suppression device, configured to suppress noise on a side of the electric motor, connecting the plurality of stator windings to the fist power line, and a second noise suppression device having a first terminal electrically connected to a first terminal of the first noise suppression device and a second terminal connected to ground.

17. The power tool according to claim 16, wherein the second noise suppression device is configured to suppress differential-mode noise on the side of the electric motor.

18. The power tool according to claim 16, wherein the control circuit further comprises a third noise suppression device having a first terminal connected to the positive electrode interface and a second terminal connected to the plurality of stator windings.

19. The power tool according to claim 16, wherein the control circuit further comprises a third suppression device having a first terminal connected to the negative electrode interface, and a second terminal connected to the plurality of stator windings.

20. The power tool according to claim 16, wherein the first noise suppression device comprises a first capacitor, and the second noise suppression device comprises a second capacitor.
